(19) United States
(12) Patent Application Publication
(10) Pub. No.: US 2012/0010913 A1
(43) Pub. Date: Jan. 12, 2012

(54) SYSTEMS AND METHODS FOR MANAGING EMPTY SEAT INVENTORY ON AN AIRPLANE

(76) Inventors: Avinash S. Lele, Palo Alto, CA (US); Sanjeev R. Kulkarni, Princeton, NJ (US)

(21) Appl. No.: 12/883,544

(22) Filed: Sep. 16, 2010

Related U.S. Application Data
(63) Continuation-in-part of application No. 12/832,733, filed on Jul. 8, 2010.
Application No. 12/832,733 is a continuation-in-part of application No. 12/845,939, filed on Jul. 29, 2010.
Application No. 12/845,939 is a continuation-in-part of application No. 12/858,925, filed on Aug. 18, 2010.

(51) Int. Cl. G06Q 10/00

(52) U.S. Cl. 705/5

(57) ABSTRACT

A system and method for managing the inventory and distribution of empty seats to take into account the preferences of customers and the desirability of sitting next to an empty seat, and the desire of the owner of the venue to efficiently exploit empty seats.

The present application is a continuation in part of co-pending application Ser. No. 12/858,925 filed Aug. 18, 2010, which is a continuation in part of application Ser. No. 12/845,939 filed Jul. 29, 2010, which is a continuation in part of application Ser. No. 12/832,733 filed Jul. 8, 2010, all of the disclosures of which are hereby incorporated by reference.

The present disclosure is directed to systems and methods for managing the inventory and distribution of empty seats. It is particularly useful for optimizing the allocation of empty seats on airplanes or in other contexts where sitting next to an empty seat may be desirable.

### BACKGROUND

Seating arrangements in a variety of venues present missed revenue opportunities stemming from seats that remain empty because they were not sold. Some customers end up being lucky enough to sit next to an empty seat even though they did not have to pay anything for the privilege of doing so. Other customers do not end up sitting next to an empty seat, even though they would have been willing to pay a premium to do so. As a result, the owner of the venue may forego significant revenue by failing to manage the numbers and locations of empty seats and seating assignments of people willing to pay to sit next to them. This can happen in a wide variety of contexts with reserved seating, such as sporting events, entertainment venues, and transportation on a common carrier.

The present disclosure is directed to systems and methods for managing the inventory and distribution of empty seats to take into account the preferences of customers and the desirability of sitting next to an empty seat, and the desire of the owner of the venue to efficiently exploit empty seats. Although the teachings of the present disclosure are applicable to any context in which some customers may be willing to pay a premium to sit next to an empty seat, the present disclosure is described with respect to the allocation of empty seats on an airline flight as an example of the teachings and principles presented herein.

Many people flying on airplanes like having an empty seat next to them, usually because the empty seat provides a little extra room or privacy. For example, a passenger can work, read, or watch a movie without having to put up with someone who is sitting right next to him and may be eavesdropping. Passengers traveling in groups enjoy similar advantages, in addition to the advantage of not having to sit with or near a stranger. For example, it can be less than desirable for a couple assigned to a window and middle seat to have to sit with a stranger in the aisle seat. Similarly, business colleagues may find it inconvenient to work together, e.g., on confidential matters, with a stranger sitting next to them or between them.

Empty seats in this context may differ from an extra seat that is purchased by a passenger. Adjacent passengers typically are not entitled to occupy the empty seat, whereas a passenger who paid for the extra seat typically has the right to occupy it. In certain cases, however, the adjacent passengers sometimes do occupy part or all of the empty seat. For example, if the passengers on either side of an empty seat are travelling together, or if both passengers mutually consent to sharing the empty seat, then the empty seat may be used in additional ways. One or both passengers might lift their armrests for more elbow room. Co-workers might put their work papers on an empty middle seat. Having an empty seat among a group of occupied seats may also permit one or more passengers to stretch out or even sleep across the seats. For instance, when a parent travels with a child and the third seat in their half-row is empty, the child can lie down across her seat and the empty seat.

Getting a seat that is adjacent to an empty seat, however, is often luck of the draw. Passengers sometimes try to increase their odds by employing various strategies, one being to choose a window seat and an aisle seat and hope that no one takes the middle seat. As more people buy tickets, however, the middle seats start being filled. Because the middle seats in the back of the plane are usually last to go due to their relative undesirability, some people refine the above strategy by choosing a window seat and an aisle seat near the back of the plane in an attempt to maximize their chances of keeping the middle seat empty.

No matter what strategy is employed, however, there is not much that a passenger can do if someone moves over and sits in the empty seat during the flight. This can occur not just in economy class, and not just with middle seats. For example, if there are only 7 first class passengers in 8 seats in a 2-2 configuration, one of the 7 passengers will end up with an empty (window or aisle) seat next to them. But one of the other 6 passengers may move during the flight, perhaps to switch from a window to an aisle, a bulkhead seat to a non-bulkhead seat, or for some other reason. An alternative strategy is to purchase an extra seat, but that is too expensive for most people because the total cost would be on the order of twice the cost of one seat.

In addition, many passengers do not have an opportunity to participate in strategies like the above because it is too late to do so by the time they buy their tickets. Consider the example of a flight that is more than about two-thirds full on a plane with a 3-3 configuration. If passengers are allowed to choose seats willy-nilly (i.e., without any management of empty seats by the airline), many of the seats that will be taken will be the window and aisle, window and middle, or aisle and middle seat-pairs in the same half row. As a result, there will be few, if any, opportunities for later passengers to sit next to an empty seat, even though some of them might have been willing to pay for the privilege. Conversely, many empty seats end up next to early-bird passengers that did not pay for them and, indeed, would have been unwilling to pay for them had the airline offered the option to do so. Business travelers are a good example of the above because they often choose their seats only a few days before the flight, when there are no more consecutive empty seats left. Many business travelers thus tend to end up in the worst seats on a flight even though they are the ones who paid the most for their tickets, and perhaps would be more likely to be willing to pay for an adjacent empty seat.

From the airline's perspective, empty seats can be a lost revenue opportunity. The airline could sell the seats at a discount to adjacent passengers, but doing so could mean displacing a subsequent prospective passenger (e.g., by turning him away or putting him on a standby list) who would have been willing to pay full price for the seat. Preventing some seats from being sold in order to preserve adjacent empty seats that were previously sold is bad because the airline ends up receiving less money for the empty seat. Conversely, the airline could decline to sell the seat at a discount to an adjacent passenger, hoping to sell the seat to a subsequent passenger for full price. But if a subsequent purchaser for the seat does not materialize, the airline is back to losing 100% of the revenue for the seat.

Waiting to sell the right to sit next to an empty seat does not necessarily solve the problem either. For example, the airline could wait until ticket sales for the flight have closed, until the time of check-in, or until the airline is otherwise certain that some empty seats will remain unoccupied. But at that point, the locations of the empty seats may be fixed relative to the passengers who have assigned seats. Thus, it may not be possible to accommodate a passenger who is willing to pay to be next to an empty seat if he did not end up next to one. Conversely, a passenger who did end up next to an empty seat may have little incentive to pay the airline anything further, because there is a good chance that the seat may remain empty whether or not he pays. See, e.g., U.S. Pat. Pub No. 2009/021227, which describes an approach for selling empty adjacent space following expiration of a time period for guests to purchase assigned space for an event.

The problem is also not solved merely by enabling passengers to request an empty seat adjacent to their reserved seat, and then allocating empty seats to some or all of the passengers who made such requests. For example, in such a system, reservations could be made until the flight is full or the flight closes, and then determining whether there are enough empty seats to satisfy the requests. If there are enough, an empty seat may be allocated to every requesting passenger. If not, the empty seats may be allocated to a subset of the requesting passengers randomly or based on a predetermined prioritization. But considerable inefficiencies may result from failing to manage which seats are selectable (from among the available seats) by passengers based on their preferences. Absent such management, for example, a passenger who is unwilling to pay a premium to sit next to an empty seat could nevertheless choose a seat that is next to an empty seat and deprive another passenger (who is willing to pay) of an opportunity to do so. As another example, two requesting passengers could end up sitting next to two empty seats, instead of sitting on either side of the same empty seat and freeing up a seat that could be sold to another passenger. This, in turn, may lead to inefficiencies in allocating empty seats when there are not enough of them to satisfy all requesting passengers. For example, it may not be possible to prioritize the allocation so as to satisfy requests that share the same empty seat before satisfying requests that do not. See, e.g., U.S. Pat. Pub. No. 2007/0250356, which describes an approach for selling provisional reservations of one or more empty seats adjacent to a reserved seat, and then allocating empty seats to passengers making such provisional reservations.

Accordingly, there is a need for a system and method for enabling an airline to manage and optimize the inventory and distribution of empty seats on an airplane flight so that empty seats end up next to people who are willing to pay for them, and so that the revenue and passenger satisfaction that may be derived from empty seats may be increased or maximized rather than being left to chance.

In one embodiment, passengers choosing seats may specify their willingness to pay for an adjacent seat to be blocked, and this information may be stored in a database. The seats that are displayed to a subsequent passenger as being selectable by that passenger may be a subset of the available seats (which, in turn, may be all unoccupied seats or some subset of them), as opposed to all available seats, and the subset may depend on whether the passenger expresses a preference to sit next to an empty seat, as well as on the information in the database concerning prior passengers' seating assignments and preferences and on factors and parameters such as expected flight load, time remaining before scheduled departure, passenger status, fare basis, etc. As a result, at any given time, the seats that are displayed to and selectable by a passenger indicating a preference to sit next to an empty seat may be different from those that are displayed to and selectable by a passenger not indicating such a preference, even though the underlying set of unoccupied seats may be the same in both cases. The number and variety of displayed seats may also depend on how tightly the airline wishes to control and manage its inventory of seats. At one or more points in time, which may or may not be prior to the time when the airline stops selling tickets for the flight, a confirmation algorithm may be run to confirm that certain seats will remain empty or blocked (e.g., will not be sold to other passengers or selectable by passengers wishing to change seats), as a function of factors and parameters such as those described above. Passengers may be charged an amount of money, airline miles, or something else for requesting and/or receiving confirmation of a blocked adjacent seat, and may receive electronic or printed confirmation that no one else may occupy the seat. If a seat is assigned to another passenger prior to being confirmed empty, the passenger may receive a full or partial refund of any money that has already been paid.

In one embodiment, the display of selectable seats may be managed to enable the airline to control (more or less stringently as desired) the inventory and distribution of empty seats on the flight. For example, the seats that are displayed to a passenger wanting to sit next to an empty seat may be restricted to those that are likely to generate the most revenue for the airline (e.g., only those empty seats that present an opportunity for the airline to obtain revenue from passengers on both sides of the empty seat, as opposed to all consecutive empty seats). A different set of seats may be displayed to a passenger not wanting to pay to sit next to an empty seat, and similarly may be restricted to those most likely to generate the most revenue (e.g., only those individual empty seats that are “landlocked” between two occupied seats, as opposed to showing all unoccupied seats). Conversely, the management of displayed seats could be less tightly controlled so as to show more unoccupied seats that satisfy the passenger's preferences. This may tend to expand seat choices that are selectable by passengers, but decrease revenues to the airline. In general, there may be a spectrum along which increased revenues may be balanced against increased passenger choice.

In one embodiment, a passenger requesting to sit next to a blocked seat may be charged for making the request, with some or all of the amount refunded if the request cannot be fulfilled because the empty seat is sold to a subsequent passenger. A bonus (e.g., 100 airline miles) could also be provided on top of the refund. The refund may be in a different form than the form in which payment was made (e.g., airline miles instead of cash). Or, a passenger making such a request may be charged for making the request, and may be charged an additional amount if the request is fulfilled (i.e., once it is confirmed that the adjacent seat will remain empty or that the seat in fact did remain empty). Or, a passenger making a request may be charged if the request is fulfilled, not merely for making the request.

In one embodiment, the confirmation that a seat will remain empty may occur once the airline can no longer sell more tickets for the flight or later, when the doors of the airplane have been closed and it is clear that no more passengers will be added to the flight. Or, confirmation may occur during or at the end of the flight if the seat remained empty during the flight. For example, after all seats to a flight have been sold, a passenger who requested an adjacent empty seat may still lose that seat during the flight due to an ad hoc change by a flight attendant to accommodate an emergent request. In this case, the passenger who requested the adjacent empty seat would not be charged (or would receive a refund) because the seat did not remain empty during the entire flight. Or, confirmation of empty seats may occur earlier, depending on one or more parameters chosen by the airline. For example, if the passenger is an elite member of the frequent flyer program, his request to sit next to an empty seat may be confirmed immediately. Or, immediate confirmation for the elite passenger may further depend on whether the expected passenger load is sufficiently low or whether his fare basis is sufficiently high.

In one embodiment, the teachings of the present disclosure may be combined with those set forth in commonly owned U.S. patent application Ser. No. 12/858,925 filed Aug. 18, 2010, which discloses systems and methods for enabling passengers to switch seats with one another depending on their willingness to pay to sit next to an empty seat or accept compensation to give up their preassigned seat for another seat and which is incorporated by reference herein. Thus, seat switching may enable the monetization of empty seats even where their inventory is not managed, or the further monetization of empty seats where, despite inventory management, demand for empty seats still exists, or seating preferences change after seat assignments have been made.

The present disclosure thus enables passengers to make requests to sit next to an empty seat, and airlines to confirm that a seat will remain empty, even before ticketing for the flight is closed, by making it possible for airlines to manage the inventory and distribution of empty seats. This may make it possible for passengers to increase their chances of sitting next to an empty seat by purchasing an opportunity to do so, rather than merely hoping that they will randomly get to do so. This also may allow monetizing empty seats that might not have remained empty but for the inventory management. This also may enable the airline to lock in a minimum amount of revenue for an empty seat but still keep open its option to sell the seat (for more money) to a passenger who will occupy the seat.

### BRIEF DESCRIPTION OF THE DRAWINGS

FIG. 1 is a simplified block diagram of one embodiment of the present disclosure.

FIG. 2 illustrates a simplified flow diagram of one embodiment of a method for passengers to select seats.

FIG. 3 illustrates one embodiment of a user interface for a passenger to select a seat that is next to an empty seat.

FIG. 4 illustrates another embodiment of a user interface for a passenger to select a seat that is next to an empty seat.

FIG. 5 illustrates one embodiment of a user interface for a passenger who is not making a request to sit next to an empty seat.

FIG. 6 illustrates another embodiment of a user interface for a passenger who is not making a request to sit next to an empty seat.

FIG. 7 illustrates one embodiment of a user interface for a passenger to select a seat when there are no seats available that are next to an empty seat.

FIG. 8 illustrates another embodiment of a user interface for a passenger to select a seat when there are no seats available that are next to an empty seat.

FIG. 9 illustrates one embodiment of a seat management protocol that may be used for a passenger who wants to sit next to an empty seat.

FIG. 10 illustrates another embodiment of a seat management protocol that may be used for a passenger who wants to sit next to an empty seat.

FIG. 11 illustrates one embodiment of a seat management protocol that may be used for a passenger who does not have to sit next to an empty seat.

FIG. 12 illustrates one embodiment of a seat management protocol that may be used for a passenger when no seats are available that are next to an empty seat.

FIG. 13 illustrates a simplified flow diagram of one embodiment of a method for confirming empty seats.

### DETAILED DESCRIPTION

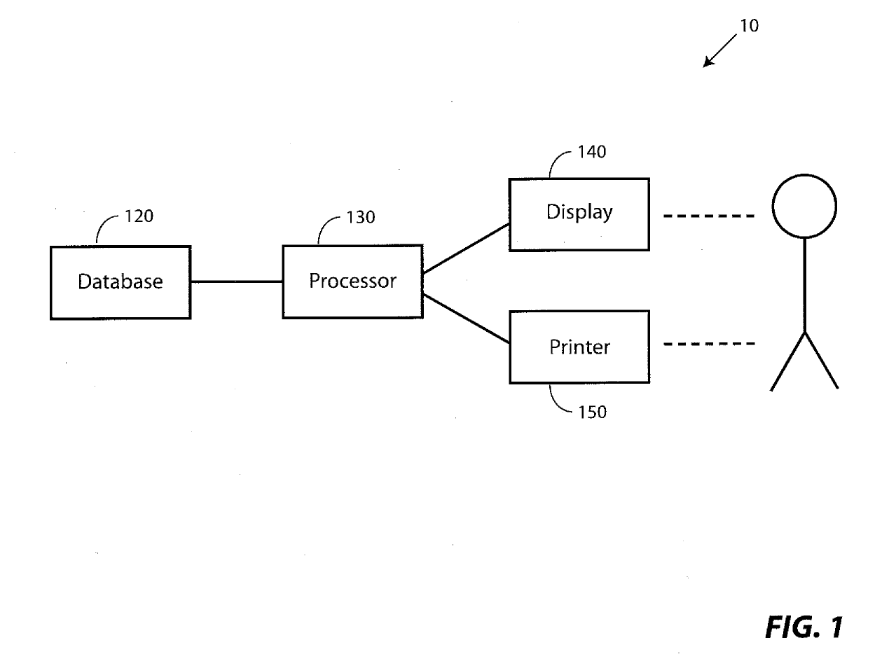

FIG. 1 shows a block diagram of a seating system 10 for an airline. Database 120 stores the seating configuration of the aircraft for a flight and seat assignments for the flight, and may include other relevant information such as passenger identification, frequent flyer status, fare basis, etc. In general, the database may store seat assignments for many or all of the airline's flights during a certain period of time (e.g., all flights in the next 365 days). For each seat on a given flight, the database may contain information that, e.g., identifies the assigned passenger or reflects that the seat is currently unassigned.

Database 120 is coupled to a processor 130 that may perform a variety of functions, including updating seat assignments that are stored in the database. The processor may also access one or more of the seat assignments so that they may be displayed to a passenger or other end user on display 140. The display may be the screen of a laptop, desktop computer, smart phone, or other device operated by the user, or a screen built into an airport check-in kiosk. In the former case, information may be communicated between processor 130 and display 140 over the Internet or some other network (not shown). The processor may be coupled to a printer 150 so that an end user may print a boarding pass or other document reflecting information such as his or her seat assignment, seating preferences, and/or confirmation that a preference to sit next to an empty seat has been made or fulfilled. The printer may be coupled to the user's laptop or other device.

Although system 10 is described in the context of being operated by an airline, it need not be. For example, it may be the system for several airlines, part of one airline, or a third party such as a consolidator, travel agency, or service like Travelocity or Expedia.

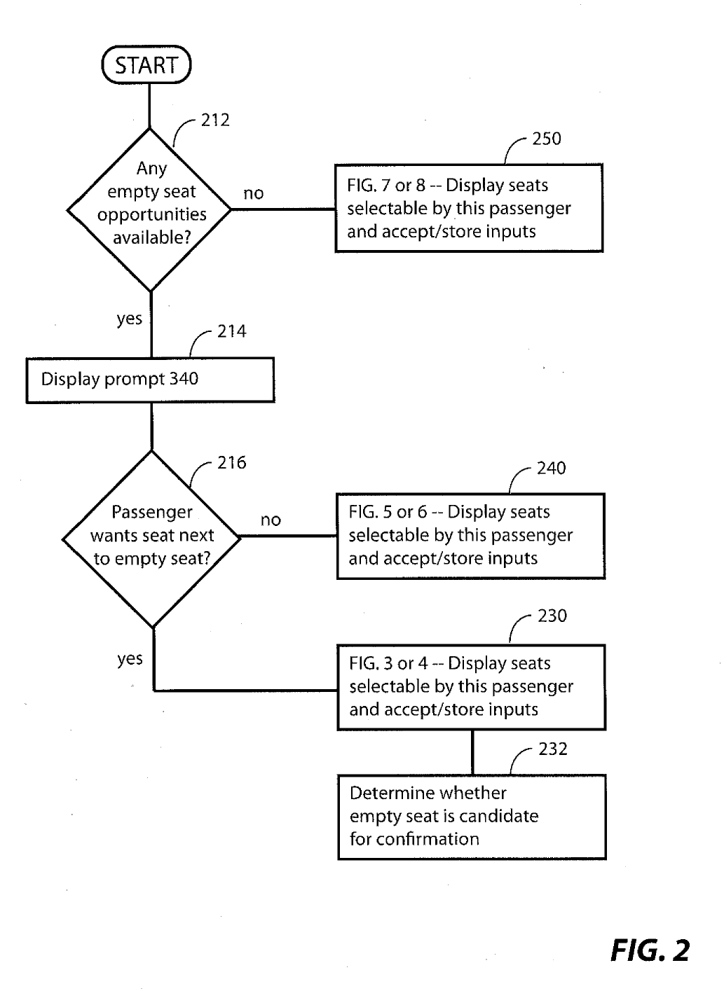

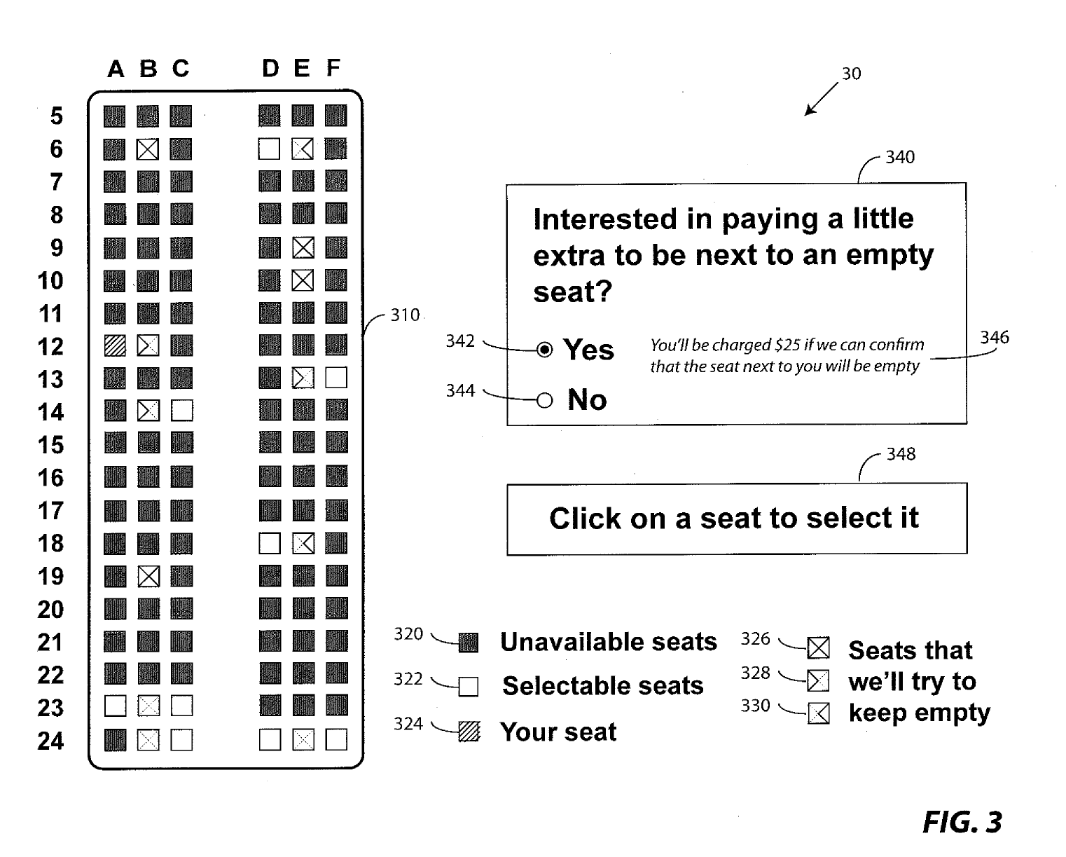

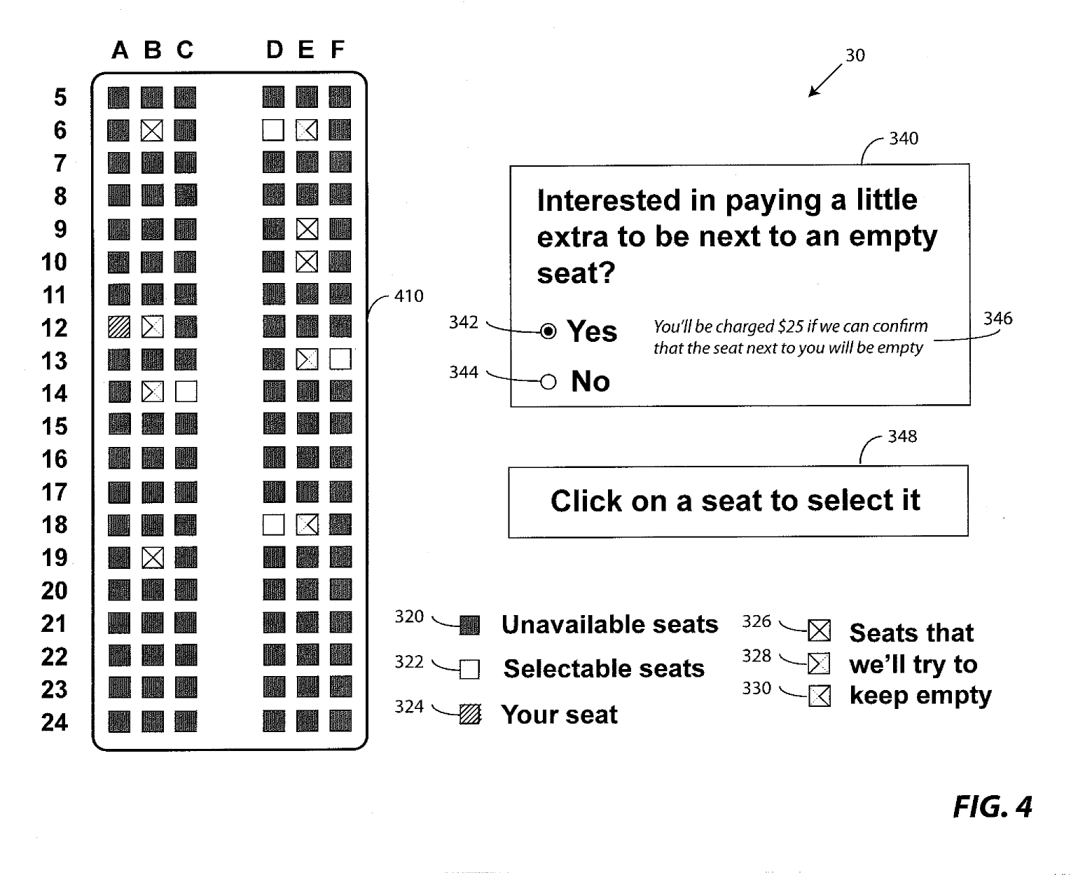

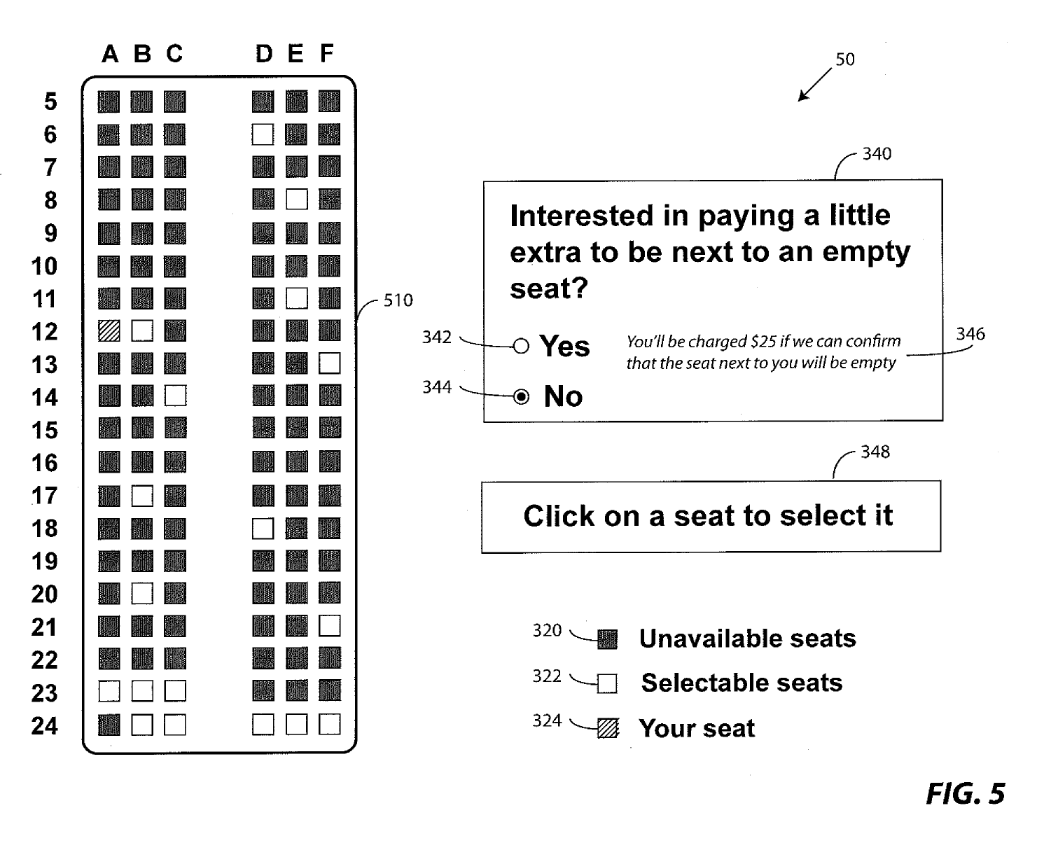

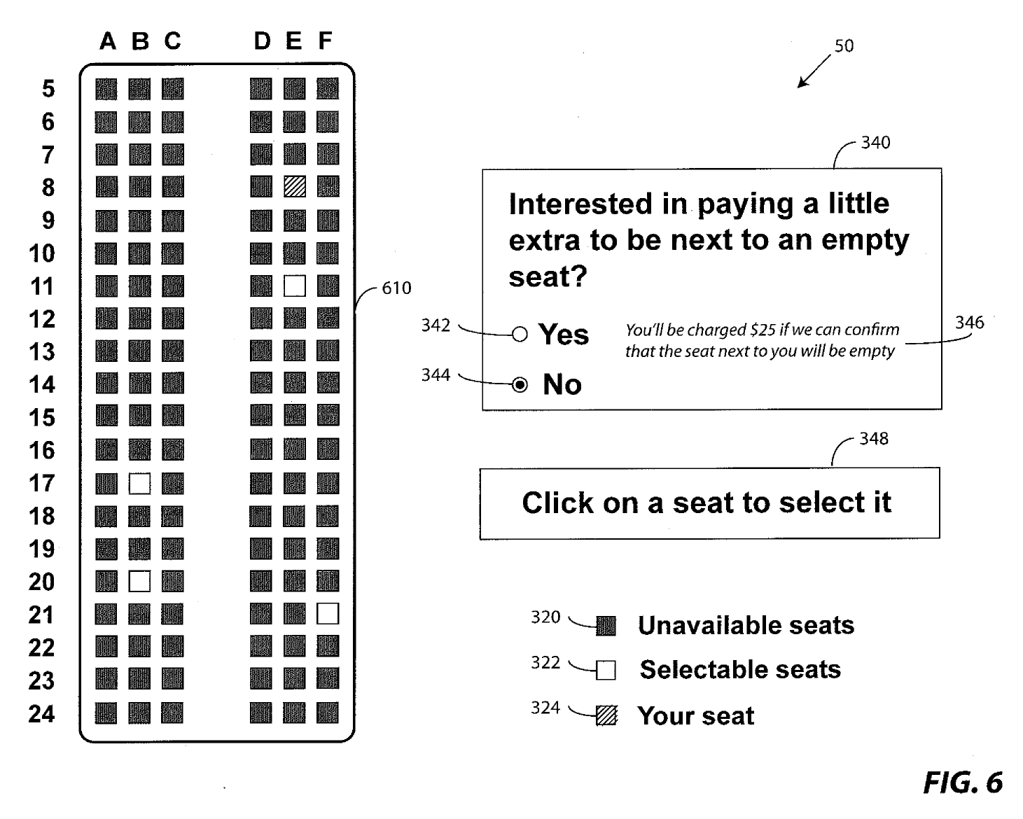

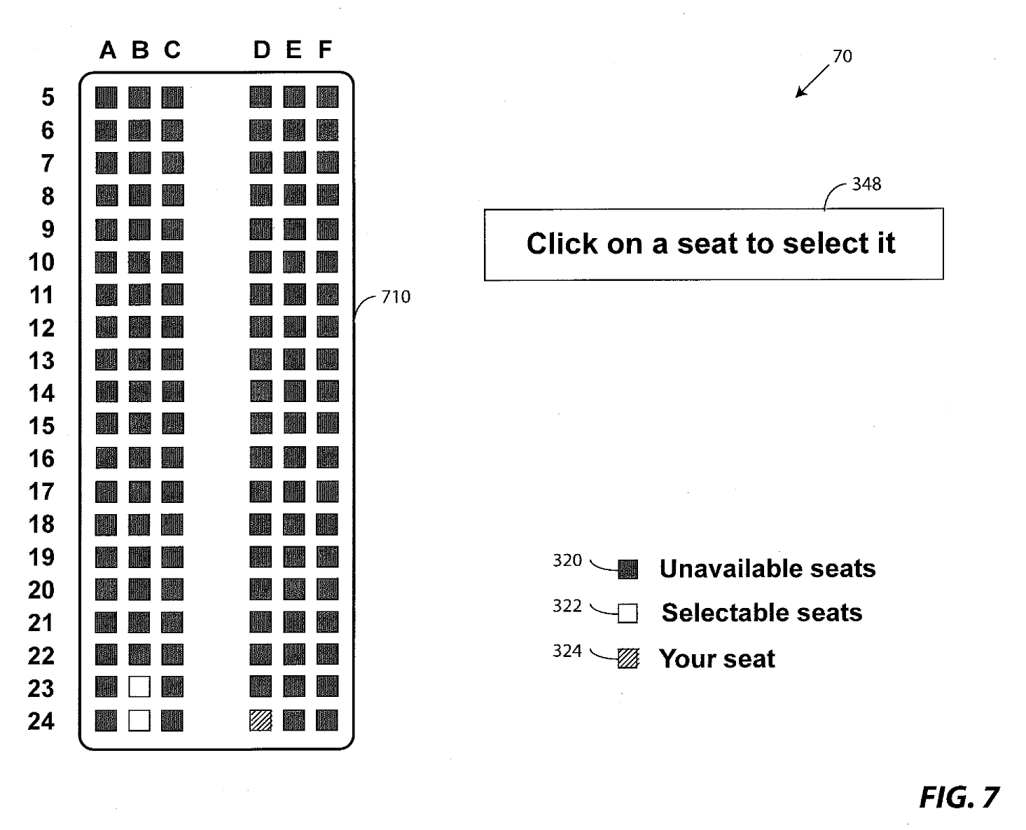

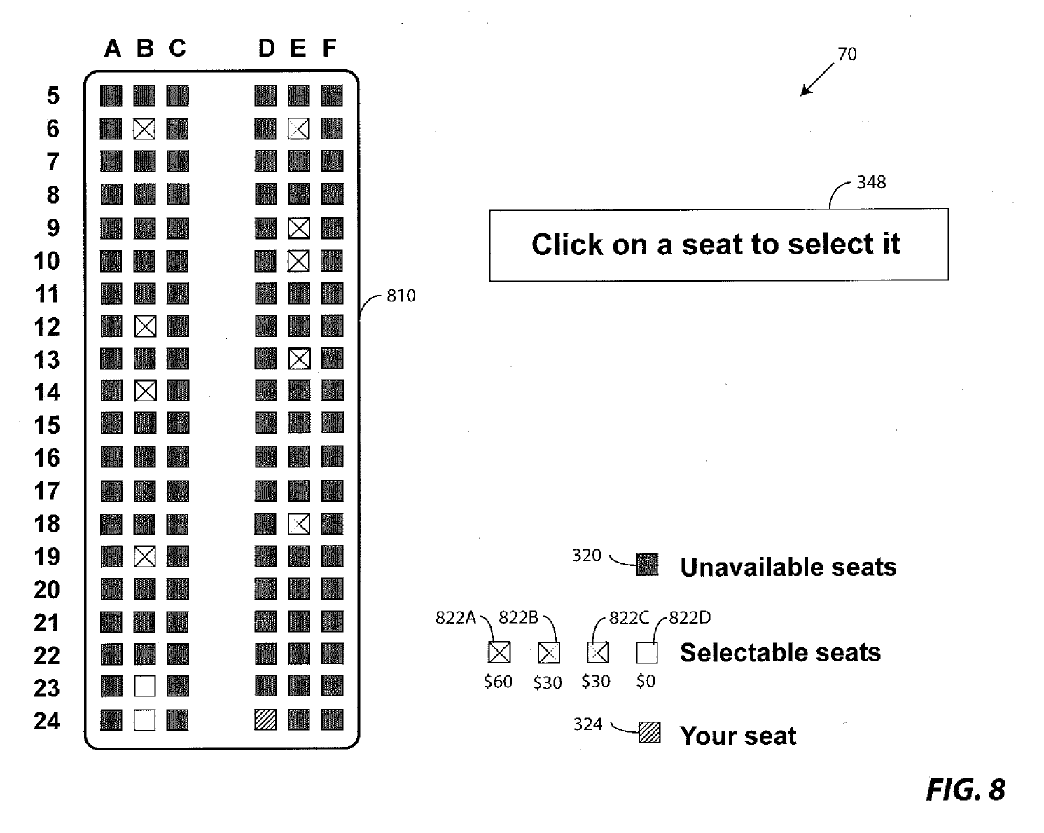

FIG. 2 shows a simplified flow diagram of one embodiment of a method that may be executed by processor 130 for passengers to select seats. In step 212, processor 130 determines whether there are any opportunities for the passenger to sit next to an empty seat (e.g., whether there are at least two adjacent seats that are not assigned to any passengers). If there are no such opportunities, in step 250, user interface 70 of FIG. 7 or 8 may be displayed. If there are such opportunities, in step 214 a prompt 340 is displayed, e.g., on display 140, asking the passenger whether she would like to sit next to an empty seat. (For convenience, such an empty seat may be referred to as a “hole.” Following this terminology, the passenger may desire to sit next to a hole, and may request a seat that is next to a hole.) If the passenger responds “yes,” as tested in step 216, the user interface of FIG. 3 or FIG. 4 may be displayed in step 230 to enable her to choose a seat. Otherwise, the user interface of FIG. 5 or FIG. 6 may be displayed in step 240 to enable her to choose a seat. These figures are described in the following subsections.

FIG. 3 shows an example of a user interface 30 that may be displayed on display 140 to enable a passenger to select seats on a particular flight. Seat map 310 may use color coding, grayscale or cross-hatch shading, or other ways to indicate which seats 320 are unavailable, which seats 322 may be selected by the passenger, and the passenger's current seat 324 if one has been selected. In general, the seat map will differ from flight to flight depending on the aircraft anticipated to be used for the flight and the seating configuration for the aircraft (e.g., 3-3 as shown, 2-3-2, etc., where the hyphen indicates an aisle on the plane). Furthermore, on larger planes, only a portion of the seat map may be shown at a time, with a scrolling feature to show seats in other parts of the plane. Pursuant to instruction 330, the passenger may select a seat by clicking on a selectable seat 322, in which case the seat map and database are updated to reflect the passenger's seat 324 and (if the passenger switched seats as opposed to picking a seat for the first time) a newly selectable seat 320.

Seat map 310 also shows seats that are being kept empty at the request of one or more passengers, unless they are later needed for a passenger who wants to occupy the seat. A seat 326 corresponding to an X mark is a seat that each of two passengers have requested to stay empty if possible. For example, the X mark in middle seat 6B indicates that the passengers in window seat 6A and aisle seat 6C have both requested that seat 6B stay empty. Pursuant to notice 346 (or a similar notice), these passengers, in order to sit next to an empty seat, have either specified their willingness to pay money, miles, or something else of value, or have status (e.g., frequent flyer, VIP, etc.), a fare basis, a ticket price, or purchased his ticket using a credit card issued or co-branded by an affiliate or partner, or has or does something else that serves as a payment substitute.

Along the same lines, a seat 328 corresponding to the left half of an X mark or a seat 330 corresponding to the right half of an X mark is a seat that one passenger has requested to stay empty. For example, the left-half-X mark in middle seat 13E indicates that the passenger to the left of that seat, i.e., in aisle seat 13D, has requested that seat 13E stay empty. As another example, the right-half-X mark in middle seat 18E indicates that the passenger to the right of that seat, i.e., in window seat 18F, has requested that seat 18E stay empty.

Furthermore, seats 332 that are currently not the subject of a request to stay empty, but are available for such requests, are indicated by dotted Xs (see, e.g., seats 23B, 24B, and 24E). Thus, the fact that neither half of the X in seat 24B is solid indicates that neither the passenger in window seat 24A nor anyone else, has submitted a request for seat 24B to be empty.

The user thus may choose to occupy any seat 322 that is indicated to be selectable. Because she has arrived at this interface by specifying that she is interested in sitting next to an empty seat (in response to prompt 340 or by selecting radio button 342), every selectable seat 322 is next to an empty seat 328, 330, or 332 that has room for at least one more empty seat request. Thus, clicking on window seat 12A, for example, as shown in FIG. 3, indicates that the passenger will occupy that seat, and also causes a left-half-X to appear in seat 12B, indicating that the passenger to the left has requested the seat to remain empty. Alternatively, the passenger could have clicked on any other selectable seat 322, in which case a (left or right, as appropriate) half-X would have appeared in the adjacent middle seat.

In the embodiment shown in FIG. 3, only middle seats may be the subject of empty seat requests (and, correspondingly, the only seats that may be chosen by a passenger who wants to sit next to an empty seat are window and aisle seats). This may be desirable to the airline for several reasons. To many people, the middle seats are the least desirable seats on the plane, so they are the most likely to remain empty. Also, a middle seat can simultaneously satisfy the desire of two passengers to be next to an empty seat, whereas a window or aisle seat can satisfy such a desire of only one passenger. As a result, a middle seat has the potential to enable the airline to generate revenue from two passengers who are willing to pay to be next to an empty seat. If, however, the airline wanted to keep non-middle seats empty for passengers wanting to sit next to empty seats, that would be reflected in the types of seats shown in interface 30.

In the embodiment shown in FIG. 3, a request for a middle seat to stay empty may be made by passengers seated to either side of the empty seat. In an alternate embodiment, however, passengers in other seats may request that a particular seat (middle or otherwise) stay empty. For example, a passenger may request that the seat directly in front of him stay empty, perhaps to avoid having the seat recline toward him while he is typing on a laptop that is on the tray table. Conversely, a passenger might want the seat directly behind him to stay empty so as to avoid being disturbed by people's knees bumping into the back of his seat. Such considerations may be one reason why an airline may want to keep window or aisle seats empty. To handle these, or similar, alternatives, interface 30 may be modified to indicate requests by people seated in front of or behind an empty seat. This could be done, e.g., by shading the top or bottom half of the square representing the empty seat. A passenger may be considered to be next to or adjacent to an empty seat when the passenger is seated to the left or to the right of the empty seat. Likewise, a passenger may be considered to be in the immediate neighborhood of an empty seat when he or she is seated to the left of, to the right of, in front of, or behind the empty seat.

As FIG. 3 shows, the seat map does not merely display information concerning the availability or unavailability of seats. The seat map also displays information about the passengers, specifically, whether they have specified a preference to sit next to an empty seat. The seat map could also or instead display other information about the passengers, including some of their attributes and/or other preferences. For example, the seat map could display information indicating which passengers are under a certain age, the sex of the passenger, or some other attribute, thereby aiding the seat selection of passengers who do or do not prefer to sit next to or near passengers with those attributes. Likewise, the seat map could display passenger preference information, for example, indicating that a passenger seated in an aisle seat prefers to sit in a window seat, enabling another passenger sitting in a window seat to swap seats with the first passenger. Or, the seat map could display something about their background (e.g., their hometown or occupation), their interest in sitting next to (or not next to) someone with a certain background, or whether they are traveling with a child or a pet.

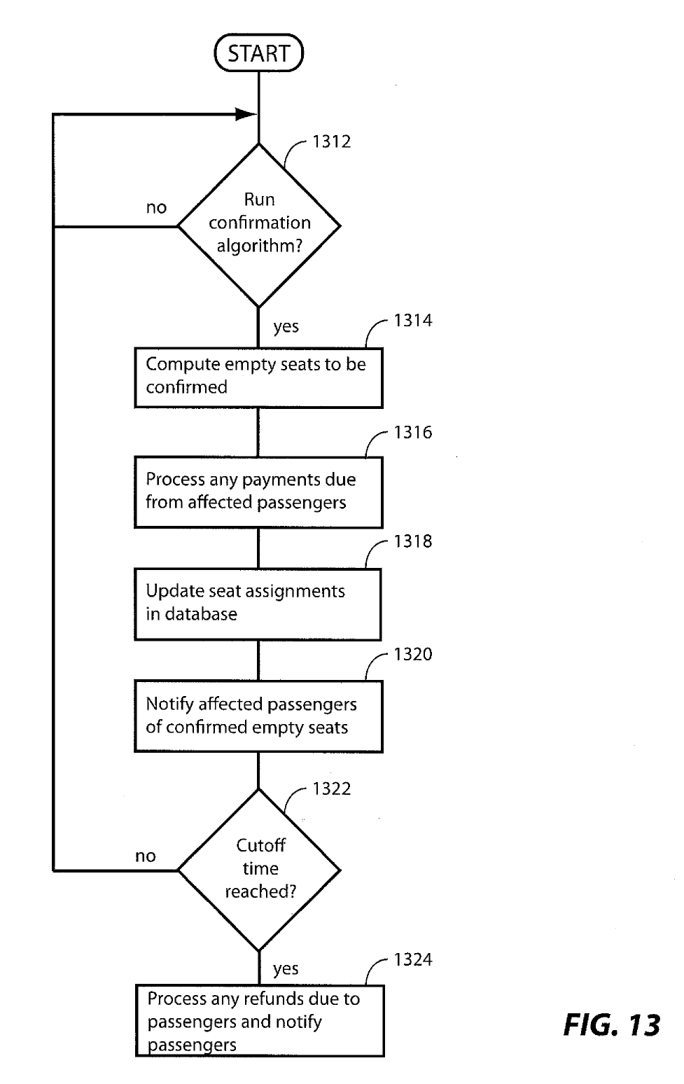

Passengers wanting to sit next to an empty seat may be charged in a variety of ways. For example, the passenger may be charged upon making a request to sit next to an empty seat. Part or all of the amount charged could be refunded (see, e.g., step 1324 of FIG. 13) if the adjacent empty seat ends up being occupied by another passenger (e.g., if the empty seat is not ultimately confirmed to be empty). In this case, if desired by the airline, a bonus (e.g., 100 airline miles, a voucher good for a free drink, $2, or something else of value) could be provided to the passenger in addition to the amount that is refunded. In an alternative implementation, none of the amount charged would be refunded (but the amount charged upfront might be correspondingly lower). In yet another embodiment, the passenger could be charged an additional amount if and when the empty seat is confirmed. In still another embodiment, consistent with notice 346 of FIG. 3, the passenger may be charged an amount only if the empty seat is ultimately confirmed, and nothing if not confirmed (e.g., no charge merely for making the request). In any of these cases, the amount that is charged could depend on flight duration (e.g., more for a longer flight) or other factors. Also, the amounts charged or refunded at different times or to different passengers may be in different forms. For example, a passenger may pay a dollar amount but be refunded in airline miles. Or, depending on the passenger status, the passenger may be allowed to pay a dollar amount or in airline miles or some other payment substitute.

Moreover, it may be desirable not to charge certain (or any) passengers requesting to sit next to an empty seat, but rather permit such requests to be made or fulfilled on the basis of frequent flyer status, VIP status, fare basis, or some other payment substitute. For example, all elite members of the airline's frequent flyer program and all passengers with full fare Y class tickets may be allowed to make such requests free of charge, while others may be charged. Indeed, in an alternative embodiment, only certain passengers could be offered the opportunity to make such requests (and may or may not be charged).

Although interface 30 displays a variety of selectable seats that are next to empty seats, it may be desirable for the airline to display only certain of those seats to manage the inventory of empty seats on the flight and the revenues associated therewith. Consider the example of a completely full flight except for the seat assignments that are shown in interface 30 for row 24. A passenger wanting to sit next to an empty seat could choose seat 24C, 24D, or 24F. If he chose 24C, seat 24B would be the subject of two empty seat requests (the preexisting request by the passenger in seat 24A plus the new request by the passenger in seat 24C). In that case, seats 24D, E, and F could be sold to three more passengers, with the total revenue for row 24 consisting of the revenue from five occupied seats and two empty seat requests, assuming that the middle seat stayed empty.

On the other hand, if the passenger chose 24D, there would be two middle seats each with one empty seat request (seats 24B and D). In that case, only two more seats (24C and 24F) could be sold to subsequent passengers, and the total revenue would be from only four occupied seats and two empty seat requests, assuming that the middle seats stayed empty. Thus, matching pairs of passengers who want to sit next to empty seats (and therefore having their individual “half-X” empty seat requests overlap into a full “X”) may result in a more efficient allocation of empty and occupied seats on the flight.

Accordingly, in one embodiment, the airline may sequence seating opportunities by making certain ones selectable before other ones. As shown in FIG. 9, the airline could take the liberal approach of showing all empty seats that are next to other empty seats. This would include two categories of seats: empty seats 910 that are next to empty middle seats with one empty seat request (such as seat 24C) and empty seats 920 that are next to empty middle seats with no empty seat requests (such as seats 24D and F). This approach is shown in FIG. 3. But making both categories selectable at the same time may lead to passengers choosing seats like 24D instead of seats like 24C, which may in turn lead to less revenue for the airline.

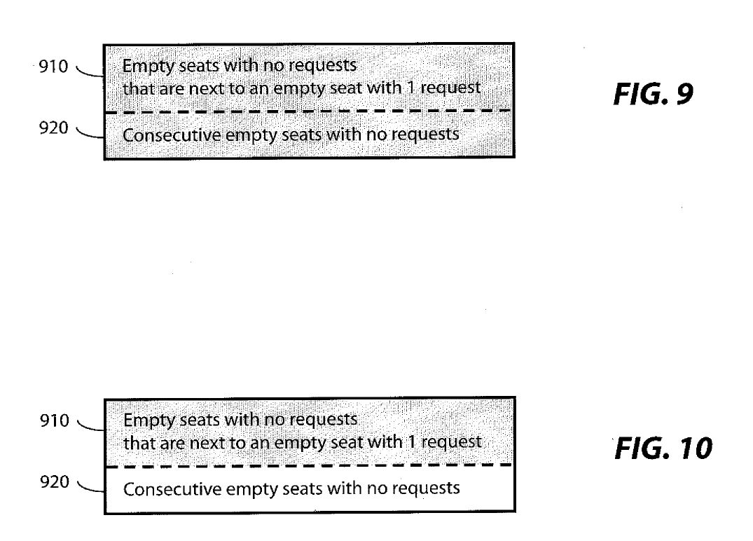

In an alternative embodiment, the interface would display only the first category of empty seats 910. This more controlled approach, shown in FIGS. 4 and 10, steers passengers toward seats that are more likely to maximize revenue to the airline before other seats (e.g., those in category 920) are made selectable. In this case, seats that are not assigned to any passenger, such as seats 24D, E, and F, nevertheless appear as “unavailable” in interface 40 of FIG. 4. The system and method of the present disclosure thus do not stop at merely recognizing that certain seats may provide higher revenue opportunities than others (e.g., because an empty seat can be monetized from multiple directions instead of just one, because an empty seat is already the subject of an empty seat request, etc.). Instead, the differential revenue opportunities are exploited to dynamically manage seat selection. Certain seats are made selectable by passengers before others are made selectable, in order to increase revenue to the airline.

It may also be desirable to display more seats to people who are considering the purchase of a ticket, as opposed to selecting seats after having purchased a ticket. For example, seats in categories 910 and 920 could be made selectable by people considering a purchase, while category 910 seats could be made selectable by people who have already purchased a ticket.

Other implementation options may be used in conjunction with, or in lieu of, sequencing selectable seats as described above. For example, if there are not many seats in category 910, some number of seats from category 920 may be made selectable as well (i.e., displayed by interface 30). As another example, all seats in both categories might be shown, but with different price tags for the seats in each category. For example, passengers could be permitted to pick from seats in the first category if they paid a premium that was enough to offset the expected revenue loss from not having two empty seat requests for the same empty seat. As another example, a greater number or variety of seats (e.g., across some or all categories) could be shown to a passenger who is willing to pay more to see more seats, has paid more for his ticket, or has elite status in the airline's frequent flyer program. Implementation options and sequencing as described above thus may be used to aid in managing the inventory and distribution of empty seats on a flight.

Referring again to the flow diagram of FIG. 2, if the passenger responds that she is not interested in paying extra to sit next to an empty seat, as tested in step 216, user interface 50 of FIG. 5 is displayed in step 240. (If the passenger changes her mind and wants to sit next to an empty seat, or is potentially interested in doing so, she may select radio button 342. Indeed, she may toggle back and forth between radio buttons 342 and 344 as desired, and doing so may display a different set of selectable and unavailable seats as described below.)

FIG. 5 shows an example of what may be displayed on user interface 50 to enable seat selection. Because the passenger is not trying to get a seat next to an empty seat, some of the seats that are shown as being selectable and unavailable on interface 50 may be different from those presented as selectable and unavailable on interface 30. For example, middle seat 8E appears as selectable to a passenger viewing interface 50, but is unavailable to a passenger viewing interface 30. This is because middle seat 8E is not next to an empty seat. As such, it is an invalid choice for a passenger who wants to sit next to an empty seat, but a valid choice for a passenger not trying to sit next to an empty seat.

Conversely, certain seats may be displayed to a passenger who wants to sit next to an empty seat but not to a passenger who does not express a preference to do so. (Seat 12A shown in FIGS. 3 and 6 is an example of such a seat.) This may be done in accordance with the seat management features of the present disclosure, to preserve empty seat opportunities for passengers who want to sit next to an empty seat, rather than have them disappear as other passengers pick their seats.

Thus, although user interfaces 30 and 50 of FIGS. 3-6 display seats based on the same information stored in database 120 (e.g., information about underlying seats, seat assignments, seating preferences, etc.), different seats may appear as “selectable” and “unavailable” to different passengers depending on the preferences they have indicated, their frequent flyer or other status, fare basis, ticket price, or other parameters in accordance with the inventory management features of the present disclosure. More specifically, the display of selectable and unavailable seats may vary from passenger to passenger, in accordance with whether the passenger has indicated a preference to sit next to an empty seat, whether other passengers on the same flight have done so, and the seat assignments and any other preferences of these passengers.

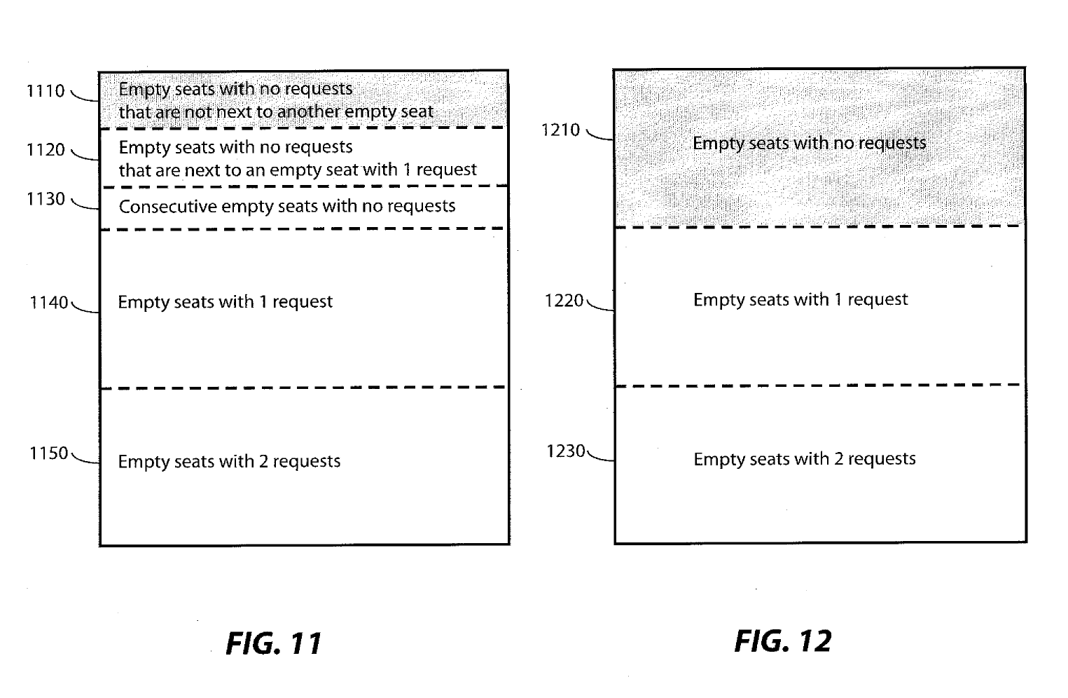

The display of selectable and unavailable seats may also depend on how tightly the airline chooses to manage its seating inventory. That is, interface 50 may display a wider or narrower range of seating options, which may be viewed as falling on a spectrum as shown in FIG. 11. On one end of the spectrum, all categories of seats 1110-1150 that satisfy the passenger's criteria may be displayed. For a passenger who does not require a seat that is next to an empty seat, this end of the spectrum results in the display of every empty seat on the plane. This provides the passenger with maximum choice, but gives the airline the least control over managing and deriving revenue from its inventory of seats.

On the other end of the spectrum, a more restrictive set of seats 1110 is displayed, as shown in FIG. 6. Unless there are no other empty seats left on the plane, empty seats that have the potential to be monetized are not displayed. These include empty seats that are already the subject of an empty seat request by one or two passengers (full-X or half-X seats, i.e., categories 1140 and 1150). These also include consecutive empty seats 1130, and empty seats 1120 that are next to half-X seats, because both types of seats fit the criteria of passengers who are willing to pay for an adjacent empty seat and thus should not be wasted on passengers who are not willing to pay. Thus, the only empty seats that are shown on interface 50 are those that are “landlocked” between two occupied seats. This helps steer (toward the landlocked empty seats) passengers who are not interested in paying extra, so that other empty seats remain selectable by the passengers who are willing to pay more to sit next to an empty seat.

Intermediate points on the spectrum may be implemented as well. For example, to strike a balance between passenger choice and airline revenue, an airline may decide to display on interface 50 only those seats in categories 1110 and 1120. The number of categories or gradations can be higher or lower than the five that are shown in FIG. 11. For example, categories 1110-30 could be collapsed into a single category of “empty seats with no requests.”

In addition, and as discussed in connection with interface 30, it may be useful to employ a downward progression along the spectrum of seats shown in FIG. 11. For example, the system could default to showing just the seats in category 1110. If and when the number of such seats drops below a certain level (e.g., there are only 3 seats, or no seats, left in category 1110), the system could also show some or all seats in category 1120. If the combined number of seats in categories 1110 and 1120 drops below a certain level, then seats in the next category could be shown, and so on. This might also depend on the amount of time until the scheduled departure of the flight, the expected load on the flight, or other factors. Managing inventory in this manner may assist in increasing the likelihood and extent to which empty seats may be monetized.

Once the passenger chooses a selectable seat using interface 50, database 120 and seatmap (510 and 610 in the examples shown in FIGS. 5 and 6) are updated to reflect the current seat 324. The updated information is used in displaying seat availability to subsequent passengers as described above.

A group of two or more passengers may use the systems and methods of the present disclosure to specify the preference of one or more members of the group to sit next to an empty seat. This may be done in a number of ways, e.g., with minor modifications to the interfaces described above. For example, interface 30 of FIG. 3 (or FIG. 4) may display the names of all passengers in the airline record in region 350. A mouse or other selection tool may be used to highlight one of the passengers and then select a seat for that passenger. This process may be repeated until seats have been selected for each passenger in the airline record.

It may be the case that fewer than all passengers in a group would like to specify a preference to sit next to an empty seat. The structure of the disclosed interfaces permits passengers to indicate their preferences individually and select seats accordingly. Consider a family of four (father, mother, son, daughter) where the father and mother are willing to pay to have an empty seat next to them, so that a stranger is not sitting with them in their half-row of three seats. The family could initially specify whether any members of the group want to pay to sit next to an empty seat (in response to prompt 340, which could frame the question for a solo passenger or a group depending on the number of passengers in the airline record). If the family's response was “yes,” interface 30 of FIG. 3 would be initially displayed. Otherwise, interface 50 of FIG. 5 would be initially displayed. The group could then use radio buttons 342 and 344 to toggle back and forth between interfaces 30 and 50 to sequentially seat the members of the group.

In the example above, interface 30 could be used first to select seats for both parents (e.g., by highlighting the father's name and selecting an aisle seat, and highlighting the mother's name and selecting a window seat, resulting in the formation of a full-X in the adjacent empty middle seat). Then, radio button 344 could be selected to display interface 50, which could be used to select seats for the children (e.g., by highlighting the daughter's name and selecting a seat, and highlighting the son's name and selecting a seat).

The description accompanying FIGS. 9-12 above explains how one or more categories of seats may be shown to a passenger depending on how tightly an airline would like to manage its inventory of seats. Referring to FIG. 11 for example, a passenger might be shown only seats in category 1110 if the airline wishes to tightly manage its inventory. If the airline wishes to provide the passenger with more choice (and is willing to give up some control), seats in categories 1110 and 1120 could be displayed.

For a group of passengers, it sometimes may be necessary to show more than just one category, if there are not enough selectable seats in the category for the group. This overflow management may be implemented in a variety of ways along a spectrum where the two ends correspond to more vs. less control in seat management. At one end of the spectrum, the minimum number of seats in the next category or categories may be shown. For example, if five passengers in a group are unwilling to pay extra to be next to an empty seat, and there are only three seats in category 1110, two seats in category 1120 may be displayed in addition to the three seats in category 1110. (If there is only one seat left in category 1120, then a seat in the next category that has selectable seats, say 1130, may be shown.) The two seats in category 1120 may be chosen by the airline randomly or in some other manner (e.g., starting at the back of the plane and moving forward, the two seats in category 1120 that are closest to some or all of the three seats in category 1110, etc.).

Or, at another point on the spectrum, more than the minimum number of seats in the next category (say four or five instead of just three, in the example above) may be shown. In this case, it may be desirable to impose restrictions that ensure that every seat in the stricter category (all three category 1110 seats in the example above) is selected, and that no more than the needed number of seats in the next category (two in the example above) are selected. For example, the interface may be designed so that all three category 1110 seats are selected before any in category 1120 are. Or, the category 1120 seats may be grayed out once two of them are selected.

Alternatively, it may be desirable to make all seats in both categories, or even in more than just those two categories (e.g., all categories), selectable along with appropriate price tags that compensate for a passenger's selecting more seats than necessary in a later category. In the example above, where the group needs five seats, all seats in categories 1110 to 1130 could be made selectable, with seats in category 1110 being free of charge and higher prices for seats in the higher categories. It may be appropriate not to charge anything if the group selects seats in a manner that exhausts all seats in the lowest category that has selectable seats before selecting any seats in the next higher category.

For a group of passengers, it sometimes may be desirable to show more than just one category, even if there are enough selectable seats in the lowest category. Consider again the example of the family of four in which the parents would like to sit alone in their half row and thus would like to choose a window and aisle seat with a full-X (i.e., doubly-blocked) empty middle seat. Referring to FIG. 9, they would not be able to do so if only category 910 seats are shown, but would be able to if category 920 seats are shown. As described above, it may be desirable for purposes of inventory management to impose checks that ensure that passengers do not beat the system. For example, if the father selected a category 920 aisle seat, the interface could automatically select the category 920 window seat in the same half-row for the mother. Or, certain seat choices could be shown as unavailable 320 or grayed out once the father chooses a category 920 seat.

Referring again to the flow diagram of FIG. 2, it may be the case that there are no more empty seats that are next to other empty seats. In this case, it may not be possible to accommodate additional passenger requests to sit next to an empty seat (unless, e.g., subsequent passengers wanting to sit next to an empty seat are allowed to displace passengers who have previously requested sitting next to an empty seat based on their higher status or fare basis, or willingness to pay an even greater premium than the previous passengers).

If the test of step 212 indicates that there are no more opportunities to sit next to an empty seat, interface 70 (an example of which is shown in FIG. 7) may be displayed. In accordance with the seat management features of the present disclosure, interface 70 may display seats as being selectable and unavailable based on the passenger's status, the fare basis for the passenger's ticket, any premium the passenger is willing to pay, the degree of control that the airline would like in managing its inventory, etc. FIG. 7 shows one example of what might be displayed after seats have filled up to the point where there are no more opportunities to sit next to empty seats. In that case, the passenger would select one of the remaining selectable seats 722, and that seat would change from being a selectable seat 722 to the current seat 724 on the seatmap 710 displayed to the passenger in question, and from selectable 722 to unavailable 720 to all other passengers.

FIG. 8 shows another example of what might be displayed on interface 70 when there are no more opportunities to sit next to empty seats. In this case, seatmap 810 might show not only empty landlocked seats (i.e., the ones shown in FIG. 7), but also other seats that the passenger may choose for a premium. The amount of the premium may be set to partially, fully, or more than fully compensate the airline for giving up revenue that it otherwise might have obtained from one or more adjacent passengers who were willing to pay to sit next to an empty seat. For example, the passenger could choose seat 14B as long as he were willing to pay an extra $60 for the seat ($60 being an amount set by the airline that exceeds the total of $50 that the two passengers in seats 19A and 19C were willing to pay to keep empty seat 19B blocked). As another example, the passenger could choose seat 18E and pay less of a premium (e.g., $30, because that empty seat is the subject of only one empty seat request, by the passenger in 18F, and thus the airline would stand to lose only $25 for that seat).

The examples shown in FIGS. 7 and 8 may be correlated to a diagram such as that shown in FIG. 12. Referring to FIG. 12, FIG. 7 shows what the seat map would look like if only category 1210 seats were displayed as being selectable, while FIG. 8 shows all three categories 1210-1230 of seats being displayed as selectable.

The diagram of FIG. 12 may inform how seats are displayed as the plane fills up even further than is shown in FIGS. 7 and 8. For example, once there are no more category 1210 seats left, the airline may make category 1220 seats selectable, and if none of those is left, category 1230 seats. In this case, the passenger would not be charged a premium to select a category 1220 or 1230 seat because lower category seats are not selectable. From the airline's perspective, it will not be able to fulfill the empty seat request of the passenger sitting next to the category 1220 seat (or the requests of the two passengers sitting next to the category 1230 seat). But the airline will be selling one more seat outright, which will typically result in more revenue for the airline than fulfilling the empty seat requests would have. Thus, on a flight that ends up being completely full, no empty seat requests will be fulfilled. As another example, if the number of empty seats left does not exceed the number of category 1230 (i.e., full-X) seats, then full-X seats will remain blocked but half-X seats will end up being occupied.

In general, half-X seats typically will be filled before full-X seats (that is, full-X seats will be the last to be filled) because, as far as empty seats go, full-X seats present the greatest revenue opportunity to the airline. Accordingly, a passenger wanting to maximize her chances of ending up next to an empty seat should choose a seat next to a half-X seat (thereby completing the X) rather than choosing a seat that is next to an empty seat with a dotted X (i.e., one that is not yet the subject of any empty seat requests). The passenger will be guided into doing so if, for example, only seats in category 910 are shown, as shown in FIG. 4. (There may be a number of other convenient, descriptive ways to refer to full-X and half-X empty seats. For example, “double request” seat may be another way to refer to a full-X seat, while “single request” seat may be used to refer to a half-X seat. Likewise, it may be useful to refer to an empty seat as having three requests or being a “triple request” empty seat if three adjacent passengers (e.g., one to the left, one to the right, and one in front of the empty seat) have requested that the seat remain empty. A quadruple request seat would refer to an empty seat where four adjacent passengers (e.g., left, right, in front of, and behind) requested that the seat be empty.)

Many alternatives to what is shown in FIGS. 7 and 8 are possible. For example, for a member of highest tier of the airline's frequent flyer program, the airline could show all of the seats in FIG. 8 with no price tags. As another example, if there were only one seat left in category 1210, the airline could make that seat selectable along with some seats in category 1220, but no seats in category 1230.

FIG. 13 shows a simplified flow diagram of one embodiment of a method that may be executed by processor 130 to confirm whether and which empty seats will remain empty. In step 1312, processor 130 determines whether it is an appropriate time to run a confirmation algorithm. This may depend on a number of parameters. For example, the algorithm may be run once it is confirmed that no more passengers will be added to the flight (e.g., when ticket sales for the flight have closed, when the door to the airplane has been closed, etc). Or, the airline may have chosen to run the algorithm periodically (e.g., monthly, then weekly, then daily as the date of the flight approaches), even before ticket sales have closed. Yet another possibility is that the algorithm is run anytime a passenger with a sufficiently high status, fare base, or ticket price, makes an empty seat request using interface 30, as depicted in step 232 of FIG. 2. Still another possibility is running the algorithm if the passenger load is sufficiently low as of a date that is sufficiently close to the date of the flight. Combinations of the foregoing, or still other parameters, factors, and conditions, may determine whether it is an appropriate time to run a confirmation algorithm.

If it is an appropriate time to do so, as indicated by test 1312, processor 130 performs a computation to identify which, if any, empty seats should be confirmed. A “confirmed empty seat” refers to a seat that will remain empty on the flight despite, e.g., any subsequent ticket purchases by new passengers. Confirmed empty seats are removed from the pool of selectable seats and are displayed on the seat map as unavailable, or in some other way that makes clear that they cannot be selected. It may also be desirable to issue a “soft confirmation” of an empty seat, which would advise the passenger that he is currently assigned to a seat that is next to an empty seat, but further specifies that the airline reserves the right to reassign him to another seat (in which case the airline might refund an amount greater than what the passenger paid to sit next to the empty seat, where the excess could be provided in a form other than in which payment was made, e.g., airline miles instead of money). A soft confirmation provides the airline with additional flexibility to sell a seat to someone else for more (or to someone with greater status) if the opportunity should arise.

This computation may involve some of the same parameters and factors that were considered in determining whether the confirmation algorithm should be run in the first place, and/or additional parameters and factors. For example, an airline may choose to run the confirmation algorithm under the following three conditions: when ticket sales have closed, whenever a platinum elite passenger requests to sit next to an empty seat, and periodically. Each time it is run periodically, other parameters (such as current passenger load, expected and/or historical load factors, time of the year, number of days before the flight date, whether any fare reductions or other promotions are on the horizon, etc.) may be taken into account in determining how many and which seats to confirm. This is because the airline may find it desirable to confirm empty seats even before the point in time when it can no longer sell additional seats, when the probability of selling the seat outright to an occupying passenger is sufficiently low as indicated by parameters such as the ones described.

Once the computation of step 1314 results in the identification of empty seats to be confirmed, any payments that are due from affected passengers are processed in step 1316. This may depend on the structure that the airline has chosen for charging passengers. In some cases, no payments may be due. For example, the airline may allow passengers with frequent flyer or VIP status to request an adjacent empty seat for free. Or, the airline may allow passengers with a sufficiently high fare basis to do so. Indeed, some tickets may have the ability to make an empty-seat-request built in to the price of the ticket or purchasable as an add-on at the time the ticket is purchased. This implementation may be desirable to business travelers, e.g., to streamline expense reporting or to make it easier or possible to obtain reimbursement for the empty seat request if the price of the request is included in the price of the ticket as opposed to being itemized separately.

In other cases, the airline might charge the passenger some amount, which may be in the form of money, airline miles, or something else of value. An amount could be charged just for making a request to sit next to an empty seat. If the request is fulfilled (i.e., if passenger ends up sitting next to a confirmed empty seat), the passenger could be charged an additional amount, or nothing further. Or, the airline might charge the passenger nothing for making the request, but some amount if the request is fulfilled. Thus, step 1316 may include the processing of various amounts that may be associated with making a request, fulfilling a request, or both, and/or the confirmation of a passenger's status, fare basis, and/or other payment substitutes.

In step 1318, once the passenger's payment or payment substitute has been confirmed, the status of the affected seats is updated in database 120. For example, the empty seat may be designated as a seat that will remain empty, even if further ticket purchases are made. Likewise, the airline records of the one or two passengers who requested that the seat remain empty are updated to reflect that those affected passenger(s) (depending on whether one or two adjacent passengers made the request) are entitled to exclude others from occupying that seat.

In step 1320, the affected passengers are notified of the adjacent empty seat, i.e., that they have the right to exclude others from occupying that seat. This information may be communicated to a passenger in any number of ways, e.g., by email or conventional mail, on a television monitor at the airport or on a website, or printed on a boarding pass (e.g., “Your seat is 18A, and the seat next to you (18B) is empty. No other passenger may occupy seat 18B.” The information also may appear on the flight manifest so that gate agents and flight attendants know which seats are confirmed empty, and which passengers paid for them to be empty. Indeed, a gate agent could stamp a passenger's boarding pass with the information prior to boarding, if the information is not pre-printed on the boarding pass. Or, it may be desirable not to provide confirmation until it is clear that no more passengers will be added to the flight, e.g., due to another flight being cancelled or delayed at the last minute. If so, a set of boarding passes for the empty seats could be printed at the gate and handed to a flight attendant just before the airplane's door is closed. The flight attendant could then hand out the empty seat passes to the affected passengers, whose payments could be processed at that time. Or, emails or other electronic communications could be sent to the affected passengers (e.g., using the airplane's inflight entertainment screens) notifying them that the seat next to them will remain empty, that they will be charged $25, etc. Or confirmation may occur during at the end of a flight if the seat remained empty during the flight, and payments could be processed at that time.

The passenger also may be advised that the empty seat confirmation is with respect to the passenger's current seat assignment only, and that an adjacent empty seat cannot be guaranteed if the passenger switches his seat. Including information on the flight manifest may also be helpful in case a flight attendant needs to make manual, onboard adjustments to the seating assignments of one or more passengers, e.g., in the event of a medical emergency.

The test in step 1322 determines whether a cutoff time has been reached (e.g., whether ticketing is now closed for the flight, or based on other conditions that establish a cutoff). If it is still possible for a new passenger to purchase a ticket for the flight, processing loops back to step 1312 for another potential round of confirmation. If not, processor 130 executes step 1324 to process any refunds that are due to affected passengers, and notifies those passengers accordingly. A refund may be due depending on the payment structure the airline has chosen. For example, if a passenger is charged some amount to make a request and that request ultimately is not fulfilled (i.e., has not been fulfilled following a “yes” branch in decision step 1322, when it is known how many passengers will be on the flight), the passenger could be refunded part or all of the amount that was charged for making the request. In addition, a bonus amount (e.g., 250 airline miles) could be given to the passenger on top of the amount that is refunded. Similarly, in the case of a passenger whose ticket included a prepaid component for empty seat requests, part or all of the prepaid amount could be refunded to the passenger. Any refund could be made in the form of money, airline miles, or some other form, and need not correspond to the form in which payment was made by the passenger (e.g., payment could be made in the form of cash and refunds could be made in the form of airline miles).

In view of the foregoing description, an airline may lock in a minimum amount of revenue for an empty seat, but still keep open its option to sell the seat to a subsequent passenger who is willing to pay more to occupy the seat (i.e., purchase the seat outright). This method of dynamic sequential optimization gives the airline two opportunities to earn money from the same seat. This provides in a higher expected payoff to the airline than methods that require the airline to decide, in the face of uncertainty, whether to sell an empty seat request early on or hold out in the hopes that it will be able to sell the empty seat later for more. An exemplary calculation demonstrates this benefit. Consider an example in which an airline could monetize an empty seat by selling empty seat requests to the two passengers on either side of the seat for a total of $100 ($50 paid by each passenger), and has a 10% chance of selling the empty seat outright to a future passenger for $1000. If the airline decides to sell the empty seat requests, it will receive $100. If, on the other hand, the airline decides to gamble, declining to fulfill the empty seat requests and instead waiting for a future passenger to purchase the seat, the expected value is (10%)($1000)=$100. But if the airline employs the sequential optimization methods of the present disclosure, expected value of the payoff to the airline will be (90%)($100)+(10%)($1000)=$190, because the airline does not have to turn down one option in order to pursue the other. Instead, the airline may hold onto one option while waiting to see if the other option materializes.

Many variations on the above-described embodiments are possible. In one embodiment, other strategies may be used to manage seat inventory. For example, the airplane cabin may be partitioned into regions that are filled first and other regions that are saved until last. This may aid in preserving some empty seat opportunities for passengers who purchased tickets later than other passengers but paid more for their tickets. This may also aid in seating groups, who often occupy middle seats that might otherwise be the subject of an empty seat request. In addition, seat management strategies could be formulated and implemented by a third party rather than the airline itself.

In another embodiment, the seat management features of the present disclosure may be applied to a subset of tickets or a subset of seats in the cabin. For example, a consolidator could implement the disclosed systems and methods for its block of seats independently of other seats on the plane. Similarly, an airline could implement the disclosed systems and methods in only half of the cabin, e.g., to measure performance against a baseline.

The interfaces shown in the accompanying figures are merely an example of how the systems and methods of the present disclosure may be implemented. For example, in an alternate embodiment, a single interface could be used (e.g., in lieu of using radio buttons 342 and 344) with different colors or shading representing the status and type of seats on the plane. Likewise, instead of having certain unoccupied seats appear to a passenger to be “unavailable,” their selection could be disabled or otherwise prohibited.

In another embodiment, the amount paid by a passenger to sit next to an empty seat could be selectable by the passenger in an auction-like format or from some preselected amounts. For example, a passenger might specify what she is willing to pay to sit next to an empty seat. In that case, empty seats associated with lower dollar amounts could be displayed as being “selectable” to subsequent passengers before those associated with higher dollar amounts. Or, a passenger might be given the option to pay to be next to an empty seat using any of two or more currencies or a combination thereof (e.g., $50, 5000 airline miles, or $25+2500 miles).

In another embodiment, adjacent empty seats could be assigned to the highest bidder. For example, passengers could place bids to be seated next to an empty seat. The bid could be directed to any empty seat, or a particular empty seat. At a predetermined time (e.g., when no more seats for the flight will be sold), the number of seats that are empty could be determined, and the N empty seats could be allocated to the N highest bidders if the bids are directed to any empty seat. If, on the other hand, each bid is directed to a particular empty seat, the highest bid for each empty seat could be accepted. The passengers who made winning bids (e.g., the N highest bids or the highest bid for particular seats) could then be assigned to seats next to the empty seats, and the other passengers would be assigned to other seats on the flight.

In another embodiment, corrective action may be taken to address situations in which flight load is sufficiently low that passengers ended up paying to sit next to an empty seat when they could have sat next to one for free. In that case, a computation could be performed to estimate a fair price for sitting next to an empty seat (for example, the highest price that would have resulted in at least one empty seat request for every empty seat). Each passenger who paid to be next to an empty seat could be refunded (in cash, to a credit card, in the form of airline miles, or in some other way) the difference between the estimated fair price and the price actually paid. The fair price could be estimated based on historical data from previous flights, economic models, or other parameters and data.

In another embodiment, corrective action may be taken to address situations in which a lower priority passenger may end up getting a better seat than a higher priority passenger (where priority may be based on, e.g., status, fare, etc.). This could occur, for example, where tight control of seat inventory early in the process leads to higher priority passengers having fewer or less desirable seat choices than lower priority passengers who select seats later, e.g., at a time when the airline has a better indication of expected flight load and determines that it can make more seats selectable. In this case, higher priority passengers could be notified (e.g., by email) of new seating opportunities or their preferences for better seats could be stored, accessed, and used to reassign their seats if and when more seats open up before making the better seats selectable by lower priority passengers.

In another embodiment, a passenger may be permitted to request that the adjacent empty seat be allocated to him alone and not shared with the passenger on the other side. For example, referring to FIG. 3, the passenger could select seat 23A and make a full-X request, instead of a half-X request, for empty seat 23B. In that case, a passenger in 23C may not be allowed to make his own empty seat request for seat 23B. And if passenger 23A's request is satisfied, he has the right to occupy the seat, as opposed to merely having the right to exclude others from occupying the seat (which typically is the case when passengers on either side of an empty seat each make a half-X request). The airline may desire to charge passenger 23A at least two times what it would charge for a half-X request, but that may depend on a number of factors (e.g., expected load, time to flight, etc.). For example, if the plane is not expected to fill up in the time remaining before the flight, the airline could offer the full-X (right to occupy the empty seat) alternative for less than twice the price of a half-X request, or at some other discount.

In another embodiment, a passenger may be permitted to request a seat that is next to two or more empty seats (e.g., an aisle seat that is next to two middle empty seats in a 2-4-2 configuration) or that is in a partial row of empty seats (e.g., a window-middle-aisle set of empty seats in a 3-3 configuration, a window-aisle or aisle-middle-middle-middle-aisle set of empty seats in a 3-5-3 configuration). In this case, the passenger could be shown some or all choices of seats that satisfy the requested criteria, and the price could vary depending on how many empty seats are being requested. For example, in a 2-4-2 wide-body configuration, a passenger could select aisle seat 15C in the center section, and request that seats 15D, E, and F remain empty. As the flight fills up, the airline could make seat 15F selectable to other passengers, then 15E, then 15D, and the passenger in seat 15C could be charged depending on how many empty seats he ended up getting.

In another embodiment, the airline might make more than one adjacent empty seat (e.g., an entire half-row) available to passengers who have requested to sit next to an empty seat, if a low passenger load is anticipated or confirmed for a flight. The assessment of passenger load could be made periodically or otherwise.

In another embodiment, a passenger may be provided with an opportunity to express a willingness to move to a different seat, perhaps for compensation. This may enable the airline to sell and fulfill more empty seat requests. For example, as a flight is filling up, the airline may reseat a passenger who has expressed a willingness to be reassigned to another seat in exchange for 500 airline miles. This may be done to accommodate a new passenger who is willing to pay to sit next to an empty seat on a flight that no longer has many, or any, empty seat opportunities left. One or more passengers may indicate their willingness to be reassigned using an interface such as those disclosed in commonly owned U.S. patent application Ser. No. 12/858,925, filed Aug. 18, 2010.

In another embodiment, different rights may be associated with empty seats. For example, one or more passengers sitting next to an empty seat could be given the right to keep other people from occupying it, the right to share it with another adjacent passenger (e.g., where both passengers can put personal items on it), use it exclusively (e.g., only one passenger can put personal items on it), the right to occupy it, etc. Moreover, different passengers could be given different rights with respect to the same empty seat. Only the window passenger and not the aisle passenger, for example, might have the right to put papers, books, or other materials on the empty seat, although both would have the right to prevent any other passenger from occupying the seat. The airline might provide the right to use to one passenger on the basis of payments (e.g., which passenger paid more for his empty seat request) or payment substitutes (e.g., which passenger has higher status). For example, passengers may be offered the opportunity to purchase a half-X as described above, a bold-half-X that would give the passenger the right to use the empty seat (but not occupy it), or a bold-full-X, that would give the passenger the right to occupy the empty seat (e.g., sleep across consecutive seats). Where an empty seat is to be shared by adjacent passengers, the seat may be subdivided using a line or other visual indicator to indicate to each passenger which part of the seat may be used by him or her. Or, the entire seat may be shared by both passengers in a mutually agreed-upon manner.

In another embodiment, passengers may be invited to request a seat adjacent to an empty seat even when there are no longer any such opportunities available. For example, the request may be stored in database 120 and accessed in the event empty seats later become available (e.g., due to a cancellation of a reservation or a ticket refund). In this case, the request might be automatically fulfilled (which may also involve reseating the passenger in another seat that is adjacent to the newly empty seat) or the passenger might be notified of, and prompted to accept or decline, the new empty seat opportunity. Or, the request may be accessed and processed along with the requests of one or more other passengers to switch seats as disclosed in commonly owned U.S. patent application Ser. No. 12/858,925, filed on Aug. 18, 2010.

In another embodiment, the features of the present disclosure may be applied to manage the inventory and distribution of window seats, aisle seats, and other desirable seats on the plane (i.e., other than empty seats and seats next to empty seats). For example, in conjunction with managing empty seats, the airline may wish to charge an amount for window and aisle seats, or charge different amounts depending on whether the seat is a window, middle, or aisle seat. The amount charged might also depend on the row. For example, seats near the front of the plane may require larger payments than those in the back. The amounts charged and the management of seats selectable by passengers could be done jointly with the management of empty seats.

In another embodiment, there may be no formal confirmation and/or notification that an empty seat will remain empty. Instead, its status as an empty seat may be known to and communicated to affected passengers by flight attendants on the flight.

In another embodiment, passengers on the flight may be made aware of the status of the seats that are empty. For example, a headrest cover that is long enough to span one and a half seats may be given to each of the two passengers who are next to an empty middle seat. Or, a headrest or seat cover may be given out for the empty seat, e.g., to indicate that it is an empty seat that other passengers may not occupy. Alternatively, video monitors or in-flight entertainment screens may be used to notify and remind passengers of the status of empty seats. For example, the screen that is in front of an empty seat may indicate that it is to remain empty (and if so, which passenger(s) paid for it to be empty), that the passenger to the left is entitled to occupy the empty seat, that either passenger may place personal items on it, etc.

In another embodiment, one or more metrics or optimization criteria may be employed to determine which seats should be displayed to a particular passenger, whether it is an appropriate time to run a confirmation algorithm, which empty seats should be confirmed, etc. One possible metric is the number of empty seat requests that are not satisfied (e.g., how many disappointed empty seat requesters) versus the number of empty seats that could have been the subject of one or more additional empty seat requests (e.g., how many people who got to sit next to an empty seat for free). It may be desirable to minimize the difference between these two numbers.

In another embodiment, quantitative approaches from dynamic optimization may be used to manage seat inventory. Algorithms and tools from various areas such as dynamic programming, Markov decision processes, and related areas may be used. By way of example, below we describe one possible way of formalizing this.

Let S denote the set of possible states of the system. For example, S may correspond to a set of possible seating configurations together with requests by previously seated passengers to sit next to an empty seat and preferences of the current passenger. Let A denote the set of possible actions. An action might refer to assigning the current passenger to a given seat, or offering a set of seats to the passenger from which the passenger can select a seat. Let Pₐ(.,.) denote a state transition probability matrix with Pₐ(s,t) denoting the probability that taking action a in state s will result in moving to state t.

Let Rₐ(s,t) denote a reward function (which may be referred to as the immediate reward or expected immediate reward) that indicates the value to the airline of a transition from state s to state t when taking action a, which happens according to the transition probability matrix. For example, Rₐ(s,t) might denote a payment received from a passenger if, while the system is in state s, the passenger indicated a preference to be seated next to an empty seat and state t is one in which the passenger's preference is fulfilled. Or, if different payments are received depending on details of the type of seat that the passenger obtains, then Rₐ(s,t) can denote these different payments as a function of t. Alternatively, if payments are received in other forms (for example, airline miles) then Rₐ(s,t) can reflect this. Another possibility is that the airline may receive or perceive a benefit in other ways such as accommodating a passenger that is a frequent flyer or has elite status or purchases his ticket with a credit card issued or co-branded by an affiliate or partner. Again, Rₐ(s,t) may reflect such benefits. Rₐ(s,t) can also be negative to reflect a net loss to the airline for moving from state s to state t when taking action a. For example, if a passenger occupies a seat that results in another passenger losing an adjacent empty seat, then a potential payment for the empty seat may be lost or refunded. In this case, Rₐ(s,t) may reflect this loss of revenue or a net loss or gain in revenue if multiple passengers are affected in different ways.

A policy □ refers to a mapping from the set of states S to actions A, i.e., □: S→A. Techniques from Markov decision processes and related areas focus on finding policies to maximize the sum of rewards or discounted rewards. That is, the objective is to find policies to maximize (or attempt to optimize) the expected value of J(□) defined as

$$J ( π ) = {\sum }_{n = 0}^{N} {γ}^{n} {R}_{π ( s ( n ) )} ( s ( n ) , s ( n + 1 ) )$$

where n may denote time or the number of passengers already seated. □ denotes a discount factor that is greater than 0 and less than or equal to 1. For no discounting, we can take □□\tilde{1} s(n) denotes the state at time n, and s(n+1) denotes the state at time n+1. □(s(n)) denotes the action taken using policy □, when in state s(n).

Different formulations and techniques for finding good policies arise depending on a number of factors such as the size of the state space, the size of the action space, whether or not the state or actions are known or only partially known, whether or not the reward function is known, whether or not the transition function is known, etc. A number of approaches from dynamic optimization such as dynamic programming, value iteration, policy iteration, approximate dynamic programming, Markov decision processes, partially observable Markov decision processes, reinforcement learning, q-learning, neural networks, and others may be applied depending on the setting.

Furthermore, the teachings of the present disclosure are not limited to specific airplane configurations. For example, the teachings could be applied to a 1-1, 1-2, 2-2, 2-3, 3-3, 2-3-2, 2-4-2, 2-5-2, 3-3-3, 3-4-3, 3-5-3, or other configuration. The categories of seats that are displayed to a passenger based on the preference or absence of a preference to sit next to an empty seat, the progression in which categories are displayed, and other aspects of the system and method may vary depending on the specific configuration. For example, in a 2-3 configuration with two seats on the left and three seats on the right, full Xs may be used to indicate empty seat requests on the left side of the plane, whereas both half and full Xs may be used for the right side. Passengers making an empty seat request on the left side may be charged more than those making one on the right side. The airline may choose to make available empty seat opportunities on the right before making them available on the left. Or, passengers may be given the opportunity to request two empty seats on the right side so as to get a half-row of three seats.

Nor are the teachings limited to flights with pre-reserved seating. Some flights have open seating where passengers are not assigned specific seats prior to boarding, but instead choose a seat once on the airplane. This is true on some shuttle flights or flights run by certain airlines. On such flights, passengers who have requested to sit next to an empty seat may be provided with cards. Such a passenger could sit down and put the card in an adjacent empty seat. Another passenger could sit down in a seat on the other side of the empty seat and put another card on the empty seat. As the plane fills up, new passengers could be directed progressively to empty seats with no cards, then those with only one card, then those with two or more cards. Refunds could be processed for passengers who were given a card but did not end up in a seat next to an empty seat. The status of empty seats could be communicated in other ways, e.g., using the video screen in front of the empty seat rather than through the use of cards.

Nor are the teachings limited to flights that have only one flight segment. In one embodiment, a passenger willing to switch seats on multiple flight segments or legs may be provided with more empty seat opportunities than a passenger who is unwilling to do so. If the flight makes a stop but there are passengers continuing to the next destination, these passengers may wish to remain in their seats rather than changing seats for the next leg. If such passengers make empty seat requests, then the management of empty seats may be done across both segments of the flight.

The systems and methods described above also may be applied to a variety of contexts other than airline seating. Seats on trains and other common carriers are some examples. Sporting events, concerts, shows, and other entertainment events are other examples. As in the context of airline seating, in these other contexts a suitable user interface could be used by ticketholders to specify a preference to sit next to an empty seat and a processor could be used to manage the inventory of seats. Ticketholders could be charged for and notified of their being seated next to an empty seat.

Although the teachings of the present disclosure are applicable to any venue offering seating arrangements to its customers, it has particular applicability to the airline industry due to the historically based ticketing and seating policies of the airline industry. For example, it is sometimes common for passengers in adjacent seats to have paid very different prices for their respective seats. Airlines sometimes increase fares as the flight time gets closer such that a last minute flyer pays a much higher price than other passengers. However, the last minute passenger will typically have a less desirable seat than those passengers that booked earlier at lower prices, and indeed, the earlier passenger may end up next to an empty seat even though he paid less for his ticket than the last-minute passenger. The present disclosure may ameliorate some of the effects of the airlines' pricing by managing the inventory of seats such that a last minute flyer, who may be willing to pay more, may request and receive a seat that is next to an empty seat. An additional benefit to the airline and its customers is that the collection and analysis of information related to receiving and fulfilling empty seat requests may afford the airline industry the ability to modify their ticketing and seating procedures to take into account their customers' preferences.

Due to security regulations and constraints, the airline may need to approve empty seat requests. However, the airline may enter into relationships with third party providers to allow access to airline passenger and seating information in order to implement the present disclosure.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims. Embodiments of the subject matter and the functional operations described in this specification can be implemented in digital electronic circuitry, or in computer software, firmware, or hardware, including the structures disclosed in this specification and their structural equivalents, or in combinations of one or more of, them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, a composition of matter affecting a machine-readable propagated signal, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Those skilled in the art will appreciate that the present invention can be practiced by other than the described embodiments, which are presented for the purposes of illustration and not of limitation, and the present invention is limited only by the claims which follow.

What is claimed:

1. A method for managing seating assignments on an airline flight, the method comprising:
receiving preference information from a passenger indicating whether the passenger prefers to sit next to an empty seat;
using a processor to identify, based on the preference information, one or more selectable seats from a plurality of available seats;
enabling the passenger to select a seat from the selectable seats; and
confirming payment or a payment substitute by the passenger if the passenger indicates a preference to sit next to an empty seat or if that preference is fulfilled.

2. The method of claim 1 wherein the selectable seats are identified according to an optimization criterion.

3. The method of claim 2 wherein the optimization criterion comprises at least one of revenue, passenger satisfaction, and number of fulfilled preferences.

4. The method of claim 1 wherein the step of identifying selectable seats comprises identifying an empty seat that was requested to be empty by at least one other passenger.

5. The method of claim 1 wherein the step of confirming occurs while tickets for the flight are still available for purchase.

6. The method of claim 1 wherein the step of confirming occurs after ticket sales for the flight have ended.

7. The method of claim 1 wherein the step of confirming occurs after boarding for the flight is complete.

8. The method of claim 1 further comprising the step of notifying the passenger whether his preference to sit next to an empty seat has been fulfilled.

9. The method of claim 1 wherein the one or more selectable seats are identified based on current passenger load, estimated passenger load, passenger status, passenger fare basis, or ticket price paid by the passenger.

10. The method of claim 1 further comprising the step of displaying the status of an empty seat on a video monitor.

11. The method of claim 1 further comprising the step of communicating rights that the passenger has with respect to an empty seat.

12. The method of claim 1 further comprising the step of displaying the selectable seats.

13. The method of claim 1 further comprising the step of issuing a refund of part or all of the payment if the passenger's indicated preference to sit next to an empty seat is not fulfilled.

14. The method of claim 13 wherein the refund is not in the form in which payment was made.

15. A method for managing seating assignments on an airline flight, the method comprising:
accessing, from a memory, seating assignments and preferences for one or more previously seated passengers, at least one of whom has indicated a preference to be seated next to an empty seat;
receiving, via a user interface, a seating preference of a new passenger that indicates whether the new passenger prefers to be seated next to an empty seat;
using a processor to identify one or more selectable seats from a plurality of available seats based on the preference of the new passenger and the seat assignments and preferences of the previously seated passengers;
displaying the selectable seats to the new passenger;
receiving the new passenger's seat selection; and
updating the memory with the preferences and seat selected by the new passenger.

16. The method of claim 15 further comprising:
displaying to the new passenger information related to the empty seat preferences of the at least one previously seated passenger.

17. A method for managing empty seats on an airline flight, the method comprising:
receiving passenger preferences from a plurality of passengers, at least one of which indicates whether or not the passenger prefers to sit next to an empty seat;
assigning a first value to a first empty seat as a function of the passenger preferences to sit next to the first empty seat;
assigning a second value to a second empty seat as a function of the passenger preferences to sit next to the second empty seat;
using a processor to compare the first and second values; and
determining, as a function of the compared values, which of the first and second empty seats will be occupied by a new passenger who is willing to pay more than the lower of the first and second values.

18. The method of claim 17 wherein the second value is a function of the preferences of more than one passenger to sit next to the second empty seat.

19. A method for optimizing seat assignments on a flight, the method comprising:
conditionally satisfying requests of a plurality of passengers to have rights with respect to another seat, wherein each passenger has specified a willingness to pay a respective amount to have rights with respect to an empty seat;
determining a rank for each empty seat based on the sum of the amounts that passengers are willing to pay to have rights with respect to the empty seat;
using a processor, comparing the ranks for at least two empty seats to identify a lowest rank empty seat;
overriding the conditional satisfaction of the requests of the one or more passengers who have specified a willingness to pay to have rights with respect to the lowest rank empty seat; and
selling the lowest rank empty seat to a new passenger who is willing to pay more than the sum of the amounts that the one or more passengers have specified a willingness to pay.

20. The method of claim 19 wherein a passenger's rights with respect to another seat comprise the right to have the another seat be empty.

21. The method of claim 20 wherein the another seat is next to the passenger's seat.

22. The method of claim 20 wherein the another seat is in front of or behind the passenger's seat.

23. The method of claim 19 wherein a passenger's rights with respect to another seat comprise the right to share the another seat with another passenger.

24. The method of claim 19 wherein a passenger's rights with respect to another seat comprise the right to use but not occupy the another seat.

25. A method for facilitating seat selection for an airplane flight, the method comprising:
accessing, from a memory, seating assignments and passenger information about one or more previously seated passengers; and
displaying to a new passenger a seat map for the flight that, in addition to showing available and unavailable seats, at least some of the passenger information.

26. The method of claim 25 wherein the passenger information includes attributes about or seating preferences of one or more of the passengers.

27. The method of claim 25 wherein the passenger information includes a preference of one or more of the passengers to sit next to an empty seat.

28. The method of claim 25 further comprising enabling the new passenger to select a seat for the flight.

29. The method of claim 25 further comprising receiving, via a user interface, a seating preference of the new passenger.
